(19) United States
(12) Patent Application Publication
(10) Pub. No.: US 2003/0122777 A1
(43) Pub. Date: Jul. 3, 2003

(54) Method and apparatus for configuring a computer system based on user distance

(76) Inventor: Andrew S. Grover, Beaverton, OR (US)

Correspondence Address: INTEL CORPORATION, P.O. BOX 5326, SANTA CLARA, CA, 95056-5326, US

(21) Appl. No.: 10/039,657

(22) Filed: Dec. 31, 2001

(51) Int. Cl. G09G 5/00; G09G 5/08

(52) U.S. Cl. 345/156; 345/158

(57) ABSTRACT

In accordance with an embodiment of the present invention, a computer system may include a sensor to measure the approximate distance between the user and the system. Based on this distance, one or more I/O devices of the computer system may be appropriately configured. For example, for one embodiment the image on a display screen of the computer system may be modified to enhance visibility. For another embodiment, the gain or volume of an audio device may be modified to enhance audibility.

The present invention relates to computer systems and more particularly to computer systems that include a sensor used to measure the distance between the system and a user. Various device parameters of the system may be modified based, at least in part, on this distance.

### BACKGROUND

Computer systems are becoming increasingly pervasive in our society, including everything from small handheld electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, workstations, and servers. Computer systems typically include input/output (I/O) devices such as speakers, microphones, display screens, cameras, etc. These I/O devices are typically configured by the manufacturer or user to provide a convenient and natural interface for the user while situated near the computer system. Unfortunately, although a particular configuration may provide for a good interface with a user situated near the system, it may not provide for a good interface for a user situated further from the system.

The present invention addresses this and other problems associated with the prior art.

### BRIEF DESCRIPTION OF THE DRAWINGS

The present invention is illustrated by way of example and not limitation in the accompanying figures in which like references indicate similar elements and in which:

FIG. 1 includes a computer system formed in accordance with an embodiment of the present invention;

FIG. 2 includes a computer system formed in accordance with an embodiment of the present invention;

FIG. 3 includes a circuit formed in accordance with an embodiment of the present invention; and

FIG. 4 includes a flow chart showing a method of an embodiment of the present invention.

### DETAILED DESCRIPTION

In accordance with an embodiment of the present invention, a computer system may include a sensor to measure the approximate distance between the user and the system. Based on this distance, one or more I/O devices of the computer system may be appropriately configured. For example, for one embodiment the image on a display screen of the computer system may be modified to enhance visibility. For another embodiment, the gain or volume of an audio device may be modified to enhance audibility.

A more detailed description of embodiments of the present invention, including various configurations and implementations, is provided below.

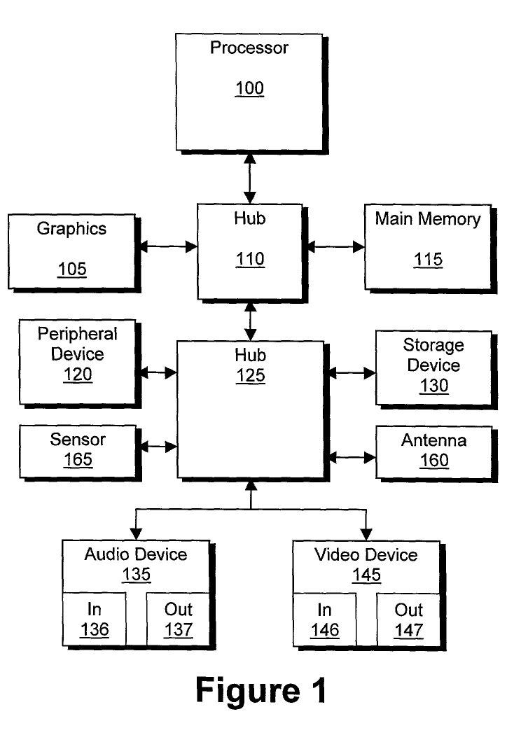

FIG. 1 includes a computer system that may be formed in accordance with an embodiment of the present invention. As shown, the computer system may include a processor 100 coupled to hub 110. Processor 100 may communicate with graphics controller 105, main memory 115, and hub 125 via hub 110. Hub 125 may couple peripheral device 120, storage device 130, audio device 135, video device 145, antenna 160, and sensor 165 to hub 110.

Audio device 135 of FIG. 1 may include an input device 136, such as a microphone, and an output device, such as a speaker. Alternatively, audio device 135 may include other input or output devices. Video device 145 may include an input device 146, such as a camera, and an output device 147, such as a display screen, projector, or other image display device. Alternatively, video device 145 may include other input or output devices. Antenna 160 may couple the computer system to one or more wireless networks in accordance with one or more wireless communication protocols. Peripheral device 120 may be one or more other peripheral devices.

In accordance with one embodiment of the present invention, sensor 165 of FIG. 1 includes components to measure an approximate distance between the sensor and a user of the computer system. For one embodiment of the present invention, sensor 165 may use an active measurement system to determine the distance to the user. For example, sensor 165 may reflect sound off the user to determine the distance using, for example, sound navigation ranging (SONAR) techniques. Alternatively, sensor 165 may reflect an electromagnetic signal (ultraviolet light, visible light, infrared light, radio waves, etc.) off the user to determine the distance using, for example, radio detecting and ranging (RADAR) techniques. For these embodiments, sensor 165 may include one or more transmitters to transmit a signal, and one or more receivers to receive the reflected signal from the user. In accordance with one embodiment of the present invention, the transmitter or receiver portion of sensor 165 may include the camera associated with input video device 146.

For an alternate embodiment of the present invention, sensor 165 of FIG. 1 may use a passive measurement system to determine the distance to the user. For example, sensor 165 may analyze an image of the user through a camera lens and adjust the focus of the lens to resolve the image. The approximate distance to the user may then be determined by the sensor using the focal length of the lens. In accordance with one embodiment of the present invention, the camera used by sensor 165 to image the user and calculate the distance to the user may be the same camera associated with input video device 146.

A method of an embodiment of the present invention may be implemented by the computer system of FIG. 1 programmed to execute instructions associated with the method. These instructions may reside, at least in part, in any machine-readable medium such as a magnetic disk (e.g. a hard drive or floppy disk), an optical disk (e.g. a CD or DVD), a semiconductor device (e.g. Flash, EPROM, or RAM), or a carrier wave (e.g. an electrical or wireless data signal), all of which are collectively represented by storage device 130 of FIG. 1.

In accordance with an embodiment of the present invention, a computer system may include more or fewer components than those shown in FIG. 1, and the components of FIG. 1 may be partitioned differently. For example, multiple components may be integrated into a single component, and single components may be divided into multiple components. Note that the term “processor” may be used herein to refer to one or more of a central processing unit, a processor of a symmetric or asymmetric multiprocessing system, a digital signal processor, a micro-controller, etc.

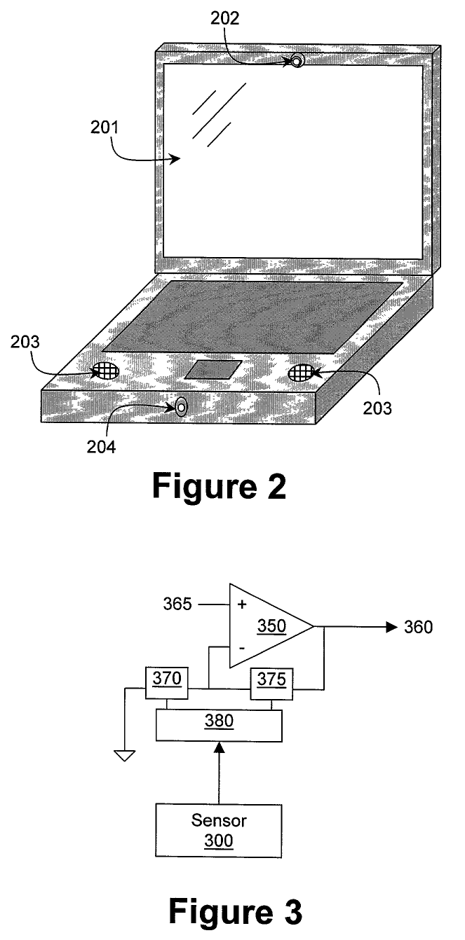

FIG. 2 includes a “clam shell” mobile computer system (e.g. a laptop, notebook, sub-notebook, etc.) formed in accordance with an embodiment of the present invention. The computer system includes a flat panel display screen 201, speakers 203, a microphone 204, and a sensor 202. Sensor 202 may be used to determine the distance to a user of the system. As described above, sensor 202 may include a camera of the computer system that a user may use to, for example, take pictures, record video, or to teleconference using appropriate software.

Note that sensor 202 of FIG. 2 is located proximal to display screen 201 such that the distance to the user, as measured by the sensor, is an approximate distance between the user and the display screen. This position of sensor 202 may be found useful for an embodiment in which the distance is used to configure an image to be displayed on display screen 201. Alternatively, sensor 202, positioned as shown in FIG. 2, may be used to measure the approximate distance between the user and microphone 204 or speakers 203 to help configure these audio devices. For an alternate embodiment of the present invention, sensor 202 may be placed elsewhere on the computer system. For example, sensor 202 may be placed more proximally to microphone 204 or speakers 203 such that the distance to the user, as measured by the sensor, is a better approximation of the distance between the user and the microphone or speakers. This alternate position of sensor 202 may be found useful for an embodiment in which the distance is used to configure the audio devices. This alternate position of sensor 202 may also be used to measure the approximate distance between the user and display screen 201 to help configure the display screen.

FIG. 3 includes a circuit formed in accordance with an embodiment of the present invention. Output 360 of op amp 350 is fed back to the inverting input of the op amp via resistor 375, and the inverting input of the op amp is coupled to ground (or Vss) via resistor 370. Input voltage 365 is provided to the non-inverting input of op amp 350. Resistors 370 and 375 are digitized resistors, the resistances of which may be set by values entered into control register 380 (which may be implemented as a single or multiple registers). The values may be entered into control register 380 directly by sensor 300, without intervention by the processor of the system, thereby placing output 360 under hardware control. Alternatively, the values may be entered into control register 380 directly or indirectly by the processor of the computer system, thereby placing output 360 under software control.

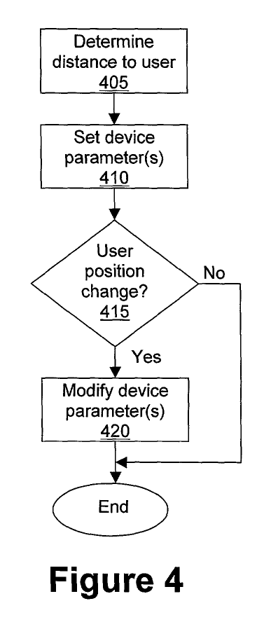

In accordance with an embodiment of the present invention, a stable reference voltage, Vref, may be provided as input voltage 365 of FIG. 3. Output 360 may be determined by the equation Vref×(1+375/370), where 375 and 370 are the resistances of resistors 375 and 370, respectively. For one embodiment of the present invention, the circuit of FIG. 3 may be used to configure an audio or display device of the computer system. For example, for an embodiment in which a display device, such as a flat panel display screen, is configured by modifying a brightness of the display screen in accordance with the measured distance between the user and the display screen, the circuit of FIG. 3 may be used to set and adjust a backlight voltage level for the display screen. Alternatively, for an embodiment in which an audio device, such as a speaker, is configured by modifying a volume level in accordance with the measured distance between the user and the speaker, the circuit of FIG. 3 may be used to set and adjust a volume level for the speaker. Configuring audio and display devices in accordance with embodiments of the present invention is described in more detail below in conjunction with FIG. 4.

FIG. 4 includes a flow chart showing a method of an embodiment of the present invention. At block 405 an approximate distance may be determined by a sensor of a computer system between the user and one or more audio or display devices. For an embodiment in which the sensor is located sufficiently proximate to the audio or display device (e.g. on same computer chassis that houses the audio or display device), this distance may be the approximate distance between the user and the sensor.

In accordance with one embodiment of the present invention, one or more device parameters are set at block 410 according to the distance determined in block 405 of FIG. 4. For example, for an embodiment in which the device is a display device, a parameter may include a display screen or image brightness, a display screen or image contrast, an image size, or a font size of text. Alternatively, for an embodiment in which the device is an audio device, a parameter may include a speaker volume or a microphone gain.

In accordance with an embodiment of the present invention, it is determined at block 415 of FIG. 4 if the position of the user has changed. For example, it may be determined at block 415, using the sensor, if the user has moved further from or closer to the audio or display device. For one embodiment of the present invention, the determination at block 415 is done automatically at periodic intervals. In accordance with an alternate embodiment, the determination at block 415 is done in response to a triggering event, such as the user pressing a “reconfigure” button or otherwise issuing a “reconfigure” command.

If the position of the user is determined not to have changed at block 415 of FIG. 4, the device parameters set at block 410 may be maintained. If, however, the position of the user is determined to have changed at block 415, one or more of the device parameters set at block 410 may be modified at block 420. For example, for an embodiment in which it is determined at block 415 that the user has moved further from the audio or display device of the computer system, one or more device parameters of the audio or display device may be modified at block 420 to enhance sound audibility or image visibility.

For example, in accordance with one embodiment of the present invention, a brightness or contrast level of an image displayed on the display device may be increased at block 420 of FIG. 4 if it is determined that the user has moved further from the display device at block 415. Alternatively, the size of the image may be increased at block 420 if it is determined that the user has moved further from the display device at block 415. For example, for an embodiment in which the image is a window, the size of the window may be increased at block 420. As another example, for an embodiment in which the image includes text, the size of the text font may be increased at block 420. Other parameters associated with the image and display device may be modified at block 420 in accordance with alternate embodiments of the present invention.

Conversely, in accordance with an alternate embodiment of the present invention, the brightness or contrast level of the image displayed on the display device may be decreased at block 420 of FIG. 4 if it is determined that the user has moved closer to the display device at block 415. Similarly, the size of the image may be decreased at block 420 of FIG. 4 if it is determined that the user has moved closer to the display device at block 415.

As another example, in accordance with another embodiment of the present invention, a volume level of the speakers (i.e. the volume level of an audio signal played by the speakers) of the computer system may be increased at block 420 of FIG. 4 if it is determined that the user has moved further from the speakers at block 415. This may improve the ability of the user to hear the audio signal at greater distances from the computer system. Alternatively, the gain of a microphone of the computer system may be increased at block 420 if it is determined that the user has moved further from the microphone at block 415. For example, for an embodiment in which the user is interfacing with the computer system via the microphone (e.g. using speech recognition, recording a message, participating in a teleconference, etc.), the gain of the microphone may be modified in accordance with user movements to improve reception. Other parameters associated with one or more audio devices may be modified at block 420 in accordance with alternate embodiments of the present invention.

Conversely, in accordance with an alternate embodiment of the present invention, the volume of the speakers of the computer system may be decreased at block 420 of FIG. 4 if it is determined that the user has moved closer to the speakers at block 415. Similarly, the gain of the microphone may be decreased at block 420 of FIG. 4 if it is determined that the user has moved closer to the microphone.

This invention has been described with reference to specific exemplary embodiments thereof. It will, however, be evident to persons having the benefit of this disclosure that various modifications and changes may be made to these embodiments without departing from the broader spirit and scope of the invention. The specification and drawings are, accordingly, to be regarded in an illustrative rather than a restrictive sense.

What is claimed is:

1. A computer system comprising:
a processor;
a display screen;
a sensor to measure an approximate distance to a user; and
a storage device storing measurement code and configuration code to be executed by the processor, the measurement code to determine the distance measured by the sensor, and the configuration code to configure an image to be displayed on the display screen according to the distance.

2. The computer system of claim 1, wherein the display screen is a flat panel display screen of a mobile system.

3. The computer system of claim 1, wherein the sensor is located proximal to the display screen such that the distance to the user is an approximate distance between the user and the display screen.

4. The computer system of claim 1, wherein the sensor uses an active or passive measurement system.

5. The computer system of claim 4, further comprising a camera, the camera including the sensor.

6. The computer system of claim 1, wherein the image includes text having a font, and wherein the configuration code is to increase a size of the font if the distance increases.

7. The computer system of claim 1, wherein the configuration code is to increase a size of the image if the distance increases.

8. The computer system of claim 1, wherein the configuration code is to modify a brightness or contrast level of the image.

9. A machine-readable medium including machine-readable instructions that, if executed by a computer system, cause the computer system to perform a method comprising:
determining an approximate distance between a user and a sensor; and
configuring an audio or display device based, at least in part, on the distance.

10. The medium of claim 9, wherein configuring the display device comprises modifying a font size of text to be displayed on the display device.

11. The medium of claim 9, wherein configuring the display device comprises modifying a size of an image to be displayed on the display device.

12. The medium of claim 9, wherein configuring the display device comprises modifying a brightness or contrast level of the display device.

13. The medium of claim 9, wherein configuring the audio device comprises modifying a gain of a microphone.

14. The medium of claim 9, wherein configuring the audio device comprises modifying a volume of a speaker.

15. A computer system comprising:
a sensor to determine an approximate distance between a user and an audio or display device; and
a circuit to determine a parameter of the device using the distance.

16. The computer system of claim 15, wherein the sensor uses an active or passive measurement system.

17. The computer system of claim 15, further comprising a camera, the camera including the sensor.

18. The computer system of claim 15, wherein the parameter is a size of text font or an image to be displayed on the display device.

19. The computer system of claim 15, wherein the parameter is a brightness or contrast level of the display device.

20. The computer system of claim 15, wherein the parameter is a gain of a microphone.

21. The computer system of claim 15, wherein the parameter is a volume of a speaker.
